(19) United States
(12) Patent Application Publication
(10) Pub. No.: US 2014/0168274 A1
(43) Pub. Date: Jun. 19, 2014

(54) ELECTRONIC DEVICE AND METHOD FOR ADJUSTING FONT SIZE OF TEXT DISPLAYED ON DISPLAY SCREEN

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: XIN-SHU WANG, Wuhan (CN); JIAN-HUNG HUNG, New Taipei (TW); MIN YANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/083,489

(22) Filed: Nov. 19, 2013

(30) Foreign Application Priority Data
Dec. 14, 2012 (CN) 201210546084X

(51) Int. Cl. G06T 3/40; G06F 3/01

(52) U.S. Cl. CPC G06T 3/40; G06F 3/011
USPC 345/661

(57) ABSTRACT

A method for automatically adjusting a font size of a text displayed on a display screen of an electronic device is provided. The electronic device includes a distance sensor. The method sets a font display rule for displaying the text on the display screen when a user uses a reader software to view the text. The distance sensor senses a current distance between the user and the display screen in real time. The method calculates a proper font size of the displayed text according to the font display rule and the current distance, generates an adjustment command according to the proper font size of the displayed text, and controls the reader software to adjust the current font size of the displayed text to the proper font size according to the adjustment command.

### BACKGROUND

1. Technical Field

Embodiments of the present disclosure relate to display systems and methods, and particularly to an electronic device and method for automatically adjusting a font size of a text displayed on a display screen of the electronic device.

2. Description of Related Art

Electronic devices, such as mobile phones, include a display screen to display information (such as a text) thereon. The text is displayed in a predetermined font size. However, when a distance between a user and the display screen is changed, the user may not be able to clearly view the text on the display screen, and it is inconvenient for the user to manually adjust the font size of the text. Therefore, there is room for improvement within the prior art.

### BRIEF DESCRIPTION OF THE DRAWINGS

FIG. 1 is a block diagram of one embodiment of an electronic device.

FIG. 2 is a flowchart of one embodiment of a method for adjusting a font size of a text displayed on a display screen of the electronic device.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable media or storage medium. Some non-limiting examples of a non-transitory computer-readable medium include CDs, DVDs, flash memory, and hard disk drives.

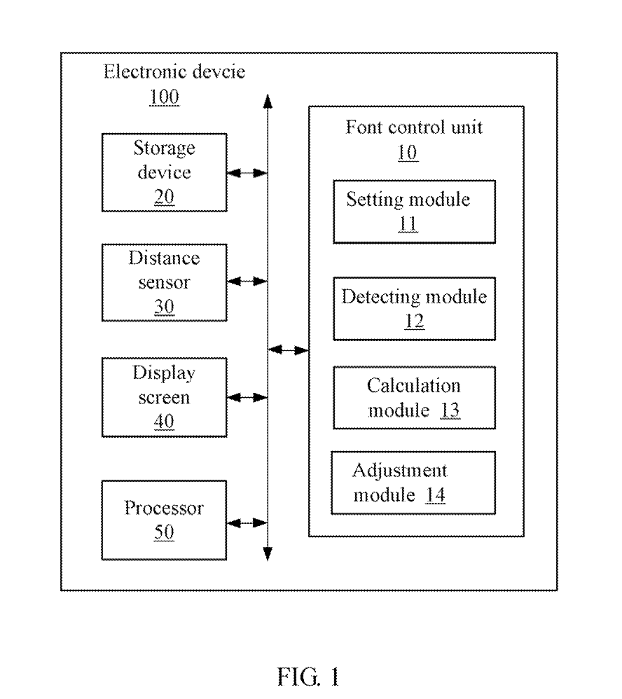

FIG. 1 is a block diagram of one embodiment of an electronic device 100 including a font control unit 10. In the embodiment, the electronic device 100 further includes, but is not limited to, a storage device 20, a distance sensor 30, a display screen 40, and at least one processor 50. Each of the components 10-50 is connected to each other through a system bus. The electronic device 100 can be a personal computer, a notebook computer, a mobile phone, a personal digital assistant (PDA) device, an electronic book device, or other computing device.

The font control unit 10 comprises computerized instructions in the form of one or more computer-readable programs, which are implemented by the electronic device 100. In the embodiment, the font control unit 10 includes, but is not limited to, a setting module 11, a detecting module 12, a calculation module 13, and an adjustment module 14. The modules 11-14 can comprise computerized instructions in the form of one or more computer-readable programs that are stored in a non-transitory computer-readable medium (such as the storage device 20) and executed by the at least one processor 50.

In one embodiment, the storage device 20 is an internal storage system, such as a flash memory, a random access memory (RAM) for temporary storage of information, and/or a read only memory (ROM) for permanent storage of information. The storage device 20 can also be an external storage system, such as an external hard disk, a storage card, or a data storage medium. The at least one processor 50 is a central processing unit (CPU) or microprocessor that performs various functions of the electronic device 100.

The distance sensor 30 senses a distance between a user of the electronic device 100 and the display screen 40 when the user uses a reader software to view a text displayed on the display screen 40. In one embodiment, the reader software includes, but is not limited to, a PDF tool, a WINDOWS OFFICE tool, and a web browser. The user uses the reader software to view the text on the display screen 40, and the text includes information such as characters, letters, and numbers.

The setting module 11 is configured to set a font display rule for displaying the text on the display screen 40 when the user views the text using the reader software. The font display rule can be preset or set by the user. In one embodiment, the font display rule includes a first rule of setting a first font size (such as 10 pt) of the text displayed on the display screen 40 when a distance between the user and the display screen 40 is not greater than a first preset value (such as 20 centimeters), a second rule of setting a second font size (such as 16 pt) of the text displayed on the display screen 40 when the distance between the user and the display screen 40 is greater than the first preset value but not greater than a second preset value (such as 80 centimeters), a third rule of increasing or decreasing a current font size of the text displayed on the display screen 40 by a predefined ratio (such as 0.05 of the first font size) per a predefined distance (such as 5 centimeters) when the distance between the user and the display screen 40 increases from the first preset value to the second preset value, and a fourth rule of decreasing the current font size of the text displayed on the display screen 40 by the predefined ratio per predefined distance when the distance between the user and the display screen 40 decreases from the second preset value to the first preset value. The second font size is greater than the first font size, and the second preset value is greater than the first preset value.

The detecting module 12 is configured to receive an activating signal when the reader software is activated, and control the distance sensor 30 to detect the current distance between the user and the display screen 40 according to the activating signal.

The calculation module 13 is configured to detect a current font size of the text displayed on the display screen 40 and calculate a proper font size of the displayed text according to the font display rule, the current distance, and the current font size. For example, if the current distance between the user and the display screen 40 is forty centimeters, the proper font size of the displayed text can be calculated as 10 pt+10 pt*(40−20)/5*0.05)=12 pt. If the current distance between the user and the display screen 40 is eighty centimeters, the proper font size of the displayed text can be calculated as 10 pt+10 pt*(80−20)/5*0.05)=16 pt.

The adjustment module 14 is configured to generate an adjustment command according to the calculated proper font size of the displayed text. The adjustment module 14 controls the reader software to adjust the current font size of the displayed text to the proper font size according to the adjustment command.

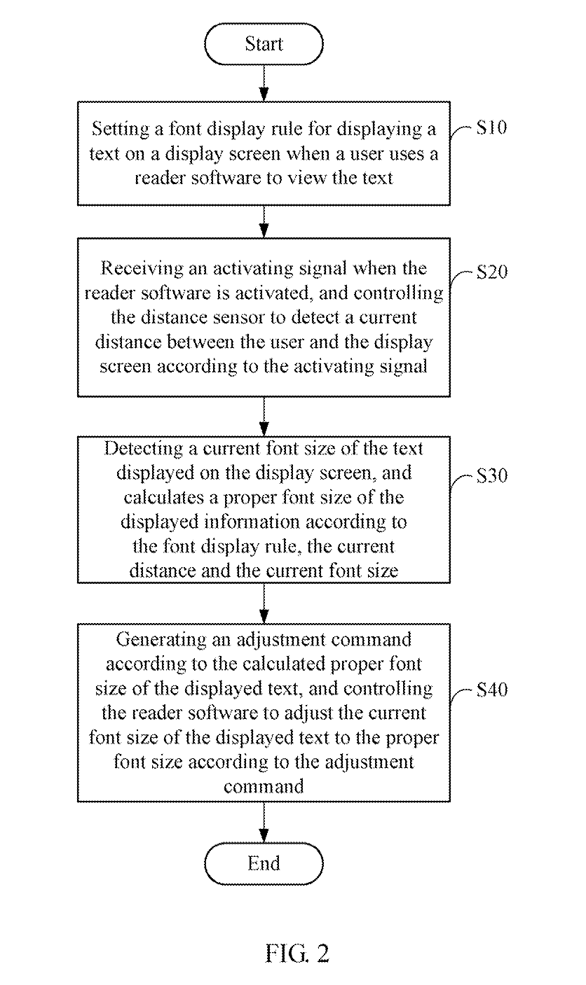

FIG. 2 is a flowchart of one embodiment of a method for adjusting a font size of a text displayed on the display screen 40 of the electronic device 100. In the embodiment, the method is performed by execution of computer-readable software program codes or instructions by the at least one processor 50 of the electronic device 100. The method can automatically adjust a font size of the text displayed on the display screen 40 according to a distance between the user and the display screen 40. Depending on the embodiment, additional steps may be added, others removed, and the ordering of the steps may be changed.

In step S10, the setting module 11 sets a font display rule for displaying a text on the display screen 40 when the user uses a reader software to view the text. In the embodiment, the reader software may be a PDF tool, a WINDOWS OFFICE tool, or a web browser. The user uses the reader software to view the text including information such as characters, letters, and numbers.

In step S20, the detecting module 12 receives an activating signal when the reader software is activated, and controls the distance sensor 30 to detect a current distance between the user and the display screen 40 according to activating signal.

In step S30, the calculation module 13 detects a current font size of the text displayed on the display screen 40, and calculates a proper font size of the displayed text according to the font display rule, the current distance, and the current font size.

In step S40, the adjustment module 14 generates an adjustment command according to the calculated proper font size of the displayed text, and controls the reader software to adjust the current font size of the displayed text to the proper font size according to the adjustment command.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a display screen, a distance sensor, and at least one processor; and
a storage device storing a computer-readable program including instructions that, which when executed by the at least one processor, causes the at least one processor to:
set a font display rule for displaying a text on the display screen when a user uses a reader software to view the text;
receive an activating signal when the reader software is activated, and control the distance sensor to detect a current distance between the user and the display screen according to activating signal;
detect a current font size of the text displayed on the display screen, and calculate a proper font size of the displayed text according to the font display rule, the current distance and the current font size; and
generate an adjustment command according to the proper font size of the displayed text, and control the reader software to adjust the current font size of the displayed text to the proper font size according to the adjustment command.

2. The electronic device according to claim 1, wherein the reader software is used to display the text comprising characters, letters, and numbers.

3. The electronic device according to claim 1, wherein the font display rule comprises a first rule of setting a first font size of the text displayed on the display screen when the distance between the user and the display screen is not greater than a first preset value, and a second rule of setting a second font size of the text displayed on the display screen when the distance between the user and the display screen is greater than the first preset value but not greater than a second preset value.

4. The electronic device according to claim 3, wherein the font display rule further comprises a third rule of increasing the current font size of the text displayed on the display screen by a predefined ratio per a predefined distance when the distance between the user and the display screen increases from the first preset value to the second preset value.

5. The electronic device according to claim 3, wherein the font display rule further comprises a fourth rule of decreasing the current font size of the text displayed on the display screen by a predefined ratio per a predefined distance when the distance between the user and the display screen decreases from the second preset value to the first preset value.

6. The electronic device according to claim 3, wherein the second font size is greater than the first font size, and the second preset value is greater than the first preset value.

7. A method for automatically adjusting a font size of a text displayed on a display screen of an electronic device, the method comprising:
setting a font display rule for displaying the text on the display screen when a user uses a reader software to view the text;
receiving an activating signal when the reader software is activated, and controlling the distance sensor to detect a current distance between the user and the display screen according to the activating signal;
detecting a current font size of the text displayed on the display screen, and calculating a proper font size of the displayed text according to the font display rule, the current distance and the current font size; and
generating an adjustment command according to the proper font size of the displayed text, and controlling the reader software to adjust the current font size of the displayed text to the proper font size according to the adjustment command.

8. The method according to claim 7, wherein the reader software is used to display the text comprising the text includes information characters, letters, and numbers.

9. The method according to claim 7, wherein the font display rule comprises a first rule of setting a first font size of the text displayed on the display screen when the distance between the user and the display screen is greater than the first preset value but not greater than a first preset value, and a second rule of setting a second font size of the text displayed on the display screen when the distance between the user and the display screen is not greater than a second preset value.

10. The method according to claim 9, wherein the font display rule further comprises a third rule of increasing the current font size of the text displayed on the display screen by a predefined ratio per a predefined distance when the distance between the user and the display screen increases from the first preset value to the second preset value.

11. The method according to claim 9, wherein the font display rule further comprises a fourth rule of decreasing the current font size of the text displayed on the display screen by a predefined ratio per a predefined distance when the distance between the user and the display screen decreases from the second preset value to the first preset value.

12. The method according to claim 9, wherein the second font size is greater than the first font size, and the second preset value is greater than the first preset value.

13. A non-transitory storage medium having stored thereon instructions that, when executed by at least one processor of an electronic device, causes the processor to perform a method for automatically adjusting a font size of a text displayed on a display screen of the electronic device, the method comprising:
setting a font display rule for displaying the text on the display screen when a user uses a reader software to view the text;
receiving an activating signal when the reader software is activated, and controlling the distance sensor to detect a current distance between the user and the display screen according to the activating signal;
detecting a current font size of the text displayed on the display screen, and calculating a proper font size of the displayed text according to the font display rule, the current distance and the current font size; and
generating an adjustment command according to the proper font size of the displayed text, and controlling the reader software to adjust the current font size of the displayed text to the proper font size according to the adjustment command.

14. The storage medium according to claim 13, wherein the reader software is used to display the text comprising characters, letters, and numbers.

15. The storage medium according to claim 13, wherein the font display rule comprises a first rule of setting a first font size of the text displayed on the display screen when the distance between the user and the display screen is not greater than a first preset value, and a second rule of setting a second font size of the text displayed on the display screen when the distance between the user and the display screen is greater than the first preset value but not greater than a second preset value.

16. The storage medium according to claim 15, wherein the font display rule further comprises a third rule of increasing the current font size of the text displayed on the display screen by a predefined ratio per a predefined distance when the distance between the user and the display screen increases from the first preset value to the second preset value.

17. The storage medium according to claim 15, wherein the font display rule further comprises a fourth rule of decreasing the current font size of the text displayed on the display screen by a predefined ratio per a predefined distance when the distance between the user and the display screen decreases from the second preset value to the first preset value.

18. The storage medium according to claim 15, wherein the second font size is greater than the first font size, and the second preset value is greater than the first preset value.
